(19) United States
(12) Patent Application Publication
(10) Pub. No.: US 2011/0281117 A1
(43) Pub. Date: Nov. 17, 2011

(54) CURABLE COMPOSITION BASED ON EPOXY RESINS AND HETERO-POLY-CYCLIC POLYAMINES

(75) Inventors: Martina Ortelt, Duelmen (DE); Dirk Fuchsmann, Marl (DE); Benedikt Hartwig, Darmstadt (DE)

(73) Assignee: EVONIK DEGUSSA GmbH, Essen (DE)

(21) Appl. No.: 13/142,665

(22) PCT Filed: Dec. 3, 2009
(86) PCT No.: PCT/EP2009/066276

§ 371 Date: Jun. 29, 2011

(30) Foreign Application Priority Data
Feb. 4, 2009 (DE) 10 2009 000 610.9
Jul. 27, 2009 (DE) 10 2009 028 019.7

(51) Int. Cl. C08L 63/00; B32B 15/092; B29C 70/30; B29C 45/00; B65H 81/00; C09D 163/00; B32B 27/38

(52) U.S. Cl. 428/418; 525/523; 525/524; 523/400; 428/413; 264/328.1; 156/169; 156/243

(57) ABSTRACT

The invention relates to curable compositions substantially comprising A) at least one epoxy resin, and B) at least one curing agent comprising a hetero-poly-cyclic ring system comprising at least two amino groups.

### FIELD OF THE INVENTION

The invention relates to curable compositions comprising A) at least one epoxy resin and B) at least one hardener comprising a heteropolycyclic ring system comprising at least two amino groups.

### PRIOR ART

Epoxy resins are prepolymers which comprise two or more epoxy groups per molecule. The reaction of said resins with a number of curing agents leads to crosslinked polymers. These polymers can be thermoset polymers; they can be used in sectors such as civil engineering (construction), composites (fiber-composite materials), potting compositions, coatings, and adhesives.

An overview of the resins and hardeners, and also of the use of these in the civil engineering sector, inclusive of their properties, is given in H. Schuhmann, “Handbuch Betonschutz durch Beschichtungen” [Handbook of coatings for protecting concrete], Expert Verlag 1992, pp. 396-428. The use of the resins and hardeners for the composites sector is described in P. K. Mallick, “Fiber-Reinforced Composites, Materials, Manufacturing, and Design”, CRC Press, pp. 60-76.

It is known by way of example from WO/1998/013407, WO/2001/009221, and WO/2005/123802, that alongside numerous other aminic hardeners for the hardening of conventional epoxy resins, for example those based on bisphenol A diglycidyl ether or bisphenol F diglycidyl ether, aliphatic or cycloaliphatic polyamines are also used, examples being diethylenetriamine (DETA) and, respectively, isophoronediamine (IPD). One of the advantages of these amines is that the resultant thermoset epoxy systems have excellent mechanical properties (e.g. high glass transition temperatures).

Resins and hardeners are conventionally produced from petrochemical sources; US 2008/0009599 describes curable epoxy systems based on renewable raw-material sources, where the epoxy component of the resin is composed of glycidyl ethers of vegetable-derived anhydrosugar alcohols.

A disadvantage with all of the known curable systems in various applications such as composites is however that reactivity is often excessive and, respectively, hardening is too quick. This severely reduces processing times and potlife values. Furthermore, an associated high level of exothermicity can lead to damage to the entire system in the form of, for example, degradation of the matrix or occurrence of internal stresses. These disadvantages are apparent firstly under the conditions of processing of the curable systems, for example those prevailing during the manufacture of rotor blades for windpower systems by the infusion process, or else in impaired final properties after hardening, e.g. discoloration.

Against this background there is therefore an increased requirement for novel, curable systems with reduced reactivity.

It was therefore an object of the invention to provide curable compositions which on the one hand have the mechanical advantages known from the prior art, but on the other hand can give a longer processing time.

### DESCRIPTION OF THE INVENTION

Surprisingly, it has been found that the curable systems described hereinafter comprising a resin and a hardener comprising polycyclic polyamines have reduced reactivity and, respectively, longer processing times, while at the same time the resultant thermosets have excellent final mechanical properties.

The present invention therefore provides curable compositions comprising A) at least one epoxy resin and B) at least one hardener comprising a heteropolycyclic ring system comprising at least two amino groups.

The invention further provides the use of curable systems of the invention.

Further advantages are the low viscosity of formulated hardeners, and the good surface properties and excellent chemicals resistance of hardened systems.

The expression “heteropolycyclic ring system” describes, in the context of the present invention, a ring system comprising at least two rings, irrespective of how these have been linked (and examples therefore include cyclophanes, catenanes, and spiro compounds), where at least one atom forming the rings is not a carbon atom.

The expression “amino group” describes, in the context of the present invention, amines which are preferably primary but also can be secondary.

The expression “cycloaliphatic compound” describes, in the context of the present invention, cyclic compounds where the ring is composed exclusively of carbon atoms, as is the case for example with cycloalkanes and -alkenes, and -alkynes.

Unless otherwise stated, all of the percentages (%) stated are percent by mass.

An epoxy resin component A) that can be used is in principle any of the epoxy resins that can be cured by amines. Examples among the epoxy resins are polyepoxides based on bisphenol A diglycidyl ether, on bisphenol F diglycidyl ether, or on cycloaliphatic types, e.g. 3,4-epoxycyclohexylepoxyethane or 3,4-epoxycyclohexyl-methyl 3,4-epoxycyclohexanecarboxylate.

Compounds preferred as component A), on the basis of good availability, in the invention are epoxy resins produced from petrochemical feedstocks.

In a curable composition of the invention it is preferable to use epoxy resins selected from the group consisting of epoxy resins based on bisphenol A diglycidyl ether, epoxy resins based on bisphenol F diglycidyl ether, and cycloaliphatic types, e.g. 3,4-epoxy-cyclohexylepoxyethane or 3,4-epoxycyclohexylmethyl 3,4-epoxycyclohexanecarboxylate, and particular preference is given here to bisphenol-A-based epoxy resins and to bisphenol-F-based epoxy resins.

The invention can also use mixtures of epoxy resins as component A).

The hardener used in component B) can comprise any of the heteropolycyclic ring systems comprising at least two amino groups.

Preferred ring systems have from two to four, particularly preferably two, rings.

The rings of the heteropolycyclic ring system are preferably rings condensed onto one another.

It is preferable that the amino groups have been bonded at respectively different rings. The ring system preferably has from two to four, particularly preferably two, amino groups.

Preferred non-carbon atoms in the ring, these being known as heteroatoms, are those selected from the group consisting of nitrogen, oxygen, and sulfur, and particular preference is given here to oxygen.

Particularly preferred heteropolycyclic ring systems used comprise polyamines derived from dianhydrosugars and desoxy compounds thereof, preferably of dianhydrohexitol. Preference is given here to diaminodianhydrodideoxyhexitols, and particular preference is given here to 2,5-diamino-1,4:3,6-dianhydro-2,5-dideoxy-D-hexitol.

Three stereoisomers thereof have hitherto been described, having the formulae (I) to (III), where preference is given to use of these (e.g. Bashford, V. G. and Wiggins, L. F. (1950). Anhydrides of polyhydric alcohols. XIII. The amino derivatives of 1, 4:3, 6-dianhydromannitol, -sorbitol, and L-iditol and their behavior towards nitrous acid. Journal of the Chemical Society 1950 371-374.): 2,5-diamino-1,4:3,6-dianhydro-2,5-dideoxy-D-mannitol (I), 2,5-diamino-1,4:3,6-dianhydro-2,5-dideoxy-D-glucitol (II), and 2,5-diamino-1,4:3,6-dianhydro-2,5-dideoxy-L-iditol (III). The three stereoisomers differ in their chirality at position 2 and 5. The amino groups here can be in the endo, endo (I), endo, exo (II), or exo, exo (III) position, based on the chair form of the annulated five-membered rings.

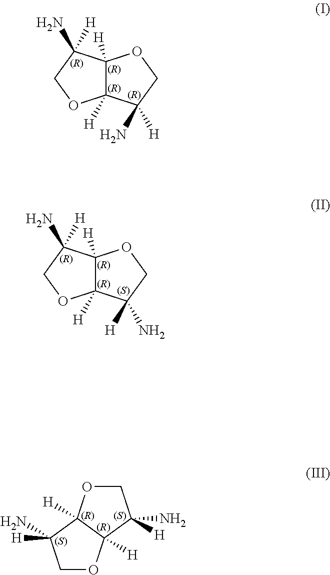

The hardener used particularly preferably comprises the compound of the formula (II), which is also termed diaminoisosorbid (DAS).

The invention can also use mixtures of hardeners as component B).

The curable compositions can also comprise further polyamines as amine hardeners, where these comprise at least two or more primary and/or secondary amino groups. Examples of polyamines of this type are diethylenetriamine, triethylenetetramine, methylenedianiline, bis(aminocyclohexyl)methane, 3,3′-dimethyl-4,4′-diaminodicyclohexylmethane, tricyclododecanediamine, norbornanediamine, N-aminoethylpiperazine, isophoronediamine, m-phenylenebis(methylamine), 1,3- and/or 1,4-bis(aminomethyl)cyclohexane, trimethylhexamethylenediamine, polyoxyalkyleneamines, polyaminoamides, and reaction products of amines with acrylonitrile and Mannich bases.

The further polyamine used preferably comprises at least one polyamine selected from the group consisting of isophoronediamine, diethylenetriamine, trimethylhexamethylenediamine, m-phenylenebis(methylamine), 1,3-bis(aminomethyl)cyclohexane, methylene-bis(4-aminocyclohexane), 3,3′-dimethyl-4,4′-diaminodicyclohexylmethane, N-aminoethylpiperazine, polyoxyalkyleneamines, polyaminoamides, and reaction products of amines with acrylonitrile and Mannich bases, and particular preference is given here to isophoronediamine, polyoxyalkyleneamines, bis(aminocyclohexyl)methane, 3,3′-dimethyl-4,4′-diaminodicyclohexylmethane, N-aminoethylpiperazine, m-phenylenebis(methylamine), and diethylenetriamine. Amounts of these used are from 0.5 to 95% by weight, preferably from 10 to 90% by weight, and particularly preferably from 20 to 60% by weight, based on all the amines used.

Component A) and component B) plus optionally further amines are generally cured in the stoichiometric ratio. However, deviations therefrom are possible to a certain extent and depend on the type of hardener and on the application.

It is preferable to use equivalent amounts of resins and hardeners here. However, deviations from the stoichiometric ratio are also possible.

Epoxy resin formulations comprise not only a resin containing one or more epoxy groups, and not only one or more hardeners, but also, varying with the appropriate field of use, modifiers, reaction accelerators, reactive diluents, solvents, and/or additives, inter alia antifoams, fillers, and/or pigments.

In the case of fiber-composite materials, the formulations also comprise by way of example the appropriate fibers and/or nonwovens.

Particularly suitable modifiers are compounds such as benzyl alcohol, alkylphenols, or hydrocarbon resins, in particular benzyl alcohol.

Among the reaction accelerators are by way of example organic acids, such as lactic acid and salicylic acid, or tertiary amine compounds, e.g. tris(dimethylaminomethyl)phenol and benzyldimethylamine.

Examples of suitable reactive diluents are mono- or polyfunctional, liquid epoxy compounds, e.g. 2-ethylhexyl glycidyl ether, hexanediol diglycidyl ether, and trimethylolpropane triglycidyl ether.

Among the solvents that can be used are by way of example aromatic hydrocarbons, such as xylene, or alcohols, such as ethanol, propanols, or butanols.

The pigments typical for coatings are moreover used, examples being titanium dioxide, iron oxide pigments, and carbon black, and fillers, e.g. talc, feldspar, and Bentones, and also additives, inter alia antifoams and leveling agents.

Systems of this type are cured at various temperatures, which vary with the intended use. By way of example, therefore, curing mostly takes place at ambient temperature for applications in the field of construction chemistry and corrosion prevention, whereas by way of example in the case of fiber-composite materials it takes place at an elevated temperature (then being known as “hot curing”).

The invention therefore also provides the use of the curable compositions of the invention where the curable compositions are cured at ambient temperature, preferably at from 10 to 35° C., particularly preferably at from 15 to 30° C.

Since curable compositions of the invention also feature homogeneous hardening at elevated temperatures, the invention also provides the use of curable compositions where the curable compositions are preferably hot-cured, at from 40 to 180° C., preferably from 40 to 180° C., particularly preferably from 50 to 130° C.

The curable compositions are used for coatings, in particular for coatings on metal, on mineral substrates, and on plastics, and also for floorcovering coatings, other coatings, polymer concrete, repair systems, anchoring compositions, adhesives, potting compositions, and impregnation systems, and in particular for fiber-composite materials. The use of a curable composition of the invention as adhesive in particular comprises the use in adhesive compositions for metal, plastic, wood, glass, MDF, and leather.

The invention further provides the use of the curable composition of the invention in coating processes, repair processes, adhesive processes, potting processes, and impregnation processes, in particular in the sector of civil engineering. The typical processing methods are found by way of example in the Lehrbuch der Lacke and Beschichtungen [Textbook of coatings], volume 7, H. Kittel, 2^{nd} edition, 2005 and H. Schuhmann, “Handbuch Betonschutz durch Beschichtungen” [Handbook of coalings for protecting concrete], Expert Verlag 1992, examples being processes for self-leveling floorcovering systems, and crack injection processes.

The invention likewise further provides the use of the curable composition of the invention for producing articles, in particular fiber-composite materials, by processes selected from the group consisting of infusion processes, injection processes, in particular vacuum injection/infusion processes prepreg processes, resin-transfer-molding processes (RTM), vacuum-assisted-resin-transfer-molding processes (VARTM), structural-reaction-injection-molding processes (SRIM), filament-winding processes, bag-molding processes, pultrusion processes, and hand-layup processes, where the prepreg process is particularly preferred. Various embodiments of the processing methods mentioned for producing articles are known to the person skilled in the art and are found inter alia in “Composites Technologien” [Composites technologies], script for ETH (Zurich) paper 151-0307-00L, version 4.0, Paolo Ermanni, Zurich, August 2007, and in P. K. Mallick, “Fiber-Reinforced Composites, Materials, Manufacturing, and Design”, CRC Press.

The present invention is described by way of example in the examples listed below, but there is no intention to restrict the invention to the embodiments mentioned in the examples; the breadth of application of the invention is that indicated in the entire description and the claims.

### EXAMPLES

### Example 1

### Results in Systems for Civil Engineering

Curable composition 1 of the invention (cC1) and comparative composition 1 not of the invention (compC1) were produced and various properties thereof were studied after the hardening process mentioned below.

The hardener components here were produced by first mixing amine and benzyl alcohol at room temperature (from 20 to 25° C.), and the epoxy resin was then added in portions. Viscosity was measured to DIN 53019.

Peak temperature was determined isothermally on a 200 g specimen by means of a temperature sensor.

Gel time was determined on the same 200 g specimen, by determining flowability.

Glass transition temperature (Tg) was determined by differential scanning calorimetry, and Shore hardness was determined to DIN 53505.

The table below shows the results of the measurements.

| | compC1 | | cC1 | |
|---|---|---|---|---|
| Hardener component | | | | |
| Isophoronediamine | 100 | g | — | |
| DAS | — | | 100 | g |
| Benzyl alcohol | 88 | g | 88 | g |
| EPON Resin 828 | 20 | g | 20 | g |
| Resin component | | | | |
| EPON Resin 828 | 421 | g | 502 | g |
| Properties | | | | |
| Initial viscosity | 2200 | mPa*s | 2000 | mPa*s |
| Viscosity doubled after | 20 | min | 70 | min |
| Peak temperature | 116°C. | | no temperature rise | |
| Gel time | 50 | min | 6.5 | hours |

Properties after curing, 23° C./50% rel. humidity

| | | |
|---|---|---|
| Tg | 49° C. | 44° C. |
| Shore hardness | 82 | 81 |
| Conversion (DSC) | 94% | 94% |
| Surface properties | very good | very good |
| (visual) | | |

Chemical resistance values after curing, 23° C./50% rel. humidity,
weight increase after storage, 28 days

| | | |
|---|---|---|
| Ethanol | 9% | 5% |
| Xylene | 1% | 0 |
| 10% strength acetic acid | 7% | 3% |
| 30% strength acetic acid | 35% | 23% |

DAS has good suitability as aminic hardener component for epoxy resins in the civil engineering sector. Formulations obtained had long processing time, good surfaces, good mechanical properties, and good chemical resistance values.

### Example 2

### Results in Systems for Composite Applications

Curable composition 2 of the invention (cC2) and comparative composition 2 not of the invention (compC2) were produced as described above and various properties thereof were studied after the hardening process mentioned below, where appropriate as described in example 1.

Heat resistance was measured by a method based on DIN EN ISO 75.

Conversion was measured by means of differential scanning calorimetry.

The table below shows the results of the measurements.

| | compC2 | | cC2 | |
|---|---|---|---|---|
| Hardener component | | | | |
| Isophoronediamine | 30 | g | — | |
| DAS | — | | 30 | g |
| Polyetheramine | 70 | g | 70 | g |
| D 230 | | | | |
| Resin component | | | | |
| EPON Resin 828 | 309 | g | 330 | g |
| 1,6-Hexanediol | 34 | g | 37 | g |
| diglycidyl ether | | | | |
| Properties | | | | |
| Initial viscosity | 600 | mPa*s | 680 | mPa*s |
| Viscosity doubled after | 125 | min | 195 | min |

| Properties after curing, | | |
|---|---|---|
| 24 hours at 23° C. + 16 hours at 50° C. | | |
| Tg | 66° C. | 71° C. |
| Heat resistance | 70° C. | 79° C. |
| Conversion (DSC) | 93% | 91% |

Tests to DIN EN ISO 527-2 (specimen 1B)

| Tensile strength | 69 | MPa | 88 | MPa |
|---|---|---|---|---|
| Tensile strain at break | 5.8% | | 5.2% | |
| Tensile modulus of elasticity | 3290 | MPa | 3520 | MPa |

Tests to DIN EN ISO 178

| | | | | |
|---|---|---|---|---|
| Flexural strength | 109 | MPa | 128 | MPa |
| Flexural modulus of elasticity | 2950 | MPa | 3570 | MPa |

The very low reactivity of DAS and its excellent mechanical properties make it highly suitable for composites.

1. A curable composition, comprising
A) at least one epoxy resin; and
B) at least one hardener comprising a heteropolycyclic ring system comprising at least two amino groups.

2. The curable composition of claim 1, wherein the
epoxy resin is produced from petrochemical feedstocks.

3. The curable composition of claim 1, wherein the
epoxy resin comprises an epoxy resin based on at least one unit selected from the group consisting of bisphenol A diglycidyl ether, bisphenol F diglycidyl ether, and cycloaliphatic epoxides.

4. The curable composition of claim 1, wherein
the heteropolycyclic ring system comprises two to four rings.

5. The curable composition of claim 4, wherein
the two to four rings of the heteropolycyclic ring system are formed by condensation.

6. The curable composition of claim 1, wherein
a heteroatom in the heteropolycyclic ring system is selected from the group consisting of nitrogen, oxygen, and sulfur.

7. The curable composition of claim 1, wherein
the heteropolycyclic ring system comprises at least one polyamine derived from dianhydrosugars and desoxy compounds thereof.

8. The curable composition of claim 1, wherein
the heteropolycyclic ring system is 2,5-diamino-1,4:3,6-dianhydro-2,5-dideoxy-D-hexitol.

9. The curable composition of claim 1, wherein
the heteropolycyclic ring system is at least one selected from the group consisting of 2,5-diamino-1,4:3,6-dianhydro-2,5-dideoxy-D-mannitol (I), 2,5-diamino-1,4:3,6-dianhydro-2,5-dideoxy-D-glucitol (II), and 2,5-diamino-1,4:3,6-dianhydro-2,5-dideoxy-L-iditol (III) of the formulae:

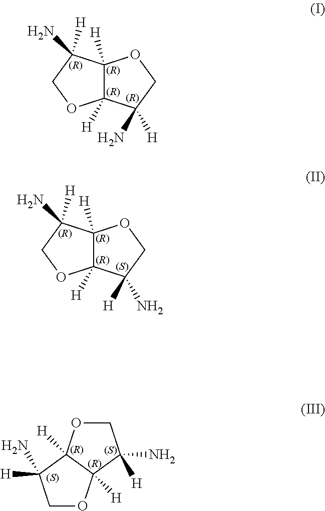

10. The curable composition of claim 1, wherein the curable composition further comprises
at least one modifier.

11. The curable composition of claim 10, wherein the
modifier is at least one selected from the group consisting of benzyl alcohol, alkylphenols, and hydrocarbon resins.

12. The curable composition of claim 1, wherein
the curable composition further comprises at least one reaction accelerator.

13. The curable composition of claim 12, wherein the
reaction accelerator comprises at least one acid selected from the group consisting of lactic acid and salicylic acid.

14. The curable composition of claim 12, wherein the
reaction accelerator comprises at least one tertiary amine.

15. The curable composition of claim 1, wherein the curable composition further comprises at least one
reactive diluent.

16. The curable composition of claim 15, wherein the
reactive diluent comprises at least one mono- or polyfunctional epoxy compound.

17. The curable composition of claim 1, wherein the curable composition further comprises at least one
solvent.

18. The curable composition of claim 1, wherein the curable composition further comprises at least one additional component selected from the group consisting of
at least one pigment and at least one filler.

19. The curable composition of claim 1, wherein the curable composition further comprises
at least one additive.

20. The curable composition of claim 1, wherein the curable composition further comprises at least one
further polyamine.

21. The curable composition of claim 20, wherein
the further polyamine comprises at least one further polyamine selected from the group consisting of isophoronediamine, diethylenetriamine, trimethylhexamethylenediamine, m-phenylenebis(methylamine), 1,3-bis(aminomethyl)cyclohexane, methylenebis(4-aminocyclohexane), 3,3′-dimethyl-4,4′-diaminodicyclohexylmethane, N-aminoethylpiperazine, polyoxyalkyleneamines, polyaminoamides and reaction products of amines with acrylonitrile and Mannich bases.

22. The curable composition of claim 20, wherein the
amount of the further polyamine is from 0.5 to 95% by weight, based on all of the amines.

23. A process of using the curable composition of claim 1, comprising curing the curable composition at a curing temperature.

24. The process of claim 23, wherein the curing temperature is from 10 to 35° C.

25. The process of claim 23, wherein the curable composition is hot-cured.

26. The process of claim 23, wherein the curing temperature is from 40 to 180° C.

27. An article obtained by the process of claim 23.

28. The article of claim 27, wherein the article comprises a coating on at least one object selected from the group consisting of a metal, a mineral substrate, and a plastic.

29. The article of claim 27, wherein the article is selected from the group consisting of a floorcovering coating, a coating, a polymer concrete, a repair system, an anchoring composition, an adhesive, a potting composition, and an impregnation system.

30. The article of claim 27, wherein the article comprises at least one fiber-composite material.

31. The process of claim 23, further comprising at least one process selected from the group of consisting of a coating process, a repair process, an adhesive process, a potting process, and an impregnation process.

32. The process of claim 23, further comprising at least one process selected from the group consisting of an infusion process, an injection process, a prepreg process, a resin-transfer-molding process (RTM), a vacuum-assisted-resin-transfer-molding process (VARTM), a structural-reaction-injection-molding process (SRIM), a filament-winding process, a bag-molding process, a pultrusion process, and a hand-layup process.

33. The curable composition of claim 9, wherein the heteropolycyclic ring system is diaminoisosorbid (II).

34. The process of claim 23, wherein the curing temperature is ambient temperature.

35. The process of claim 32, wherein the process produces fiber composite materials.
